(19) United States
(12) Patent Application Publication
(10) Pub. No.: US 2005/0269302 A1
(43) Pub. Date: Dec. 8, 2005

(54) Laser machine tool with beam analyzer

(76) Inventor: Armin Horn, Ditzingen (DE)

Correspondence Address: PEPE & HAZARD, LLP, 225 ASYLUM ST., HARTFORD, CT, 06103, US

(21) Appl. No.: 11/145,481

(22) Filed: Jun. 3, 2005

(30) Foreign Application Priority Data
Jun. 5, 2004 (EP) 04 013 314.2

(51) Int. Cl. B23K 26/10

(52) U.S. Cl. 219/121.78; 219/121.83

(57) ABSTRACT

A laser machine tool includes an analyzer for determining at least one beam characteristic of the laser beam. The guidance system of the laser machine tool moves the laser beam relative to the beam analyzer in the transverse direction to determine at least one beam characteristic of the laser beam, and the numeric control for the machine tool processes the information to control the laser beam in the machining operation.

### BACKGROUND OF THE INVENTION

This invention relates to a laser machine tool for the machining of workpieces, and incorporating a functional machining unit, a drive mechanism by means of which, with the associated functional unit set in motion, the focal spot of a laser beam and a workpiece can be positioned and/or moved relative to each other for the machining of the workpiece, and incorporating a beam analyzing component for the determination of at least one beam characteristic of the laser beam.

Laser machine tools have been in existence in a variety of designs, for instance as laser cutting and laser welding machines. An example thereof is the laser cutting machine described in EP 1 083 019 A2 (U.S. Pat. No. 6,509,545 issued Jan. 21, 2003). For processing the workpiece, the focal spot of the laser beam serving as the machining tool and the workpiece to be processed must be moved relative to each other. Such relative movement may take place for instance along the surface of the workpiece to be machined and the position of the focal spot of the beam relative to the thickness dimension of the workpiece before and during the machining process. For the job specific relative movement, the prior art uses drive mechanisms in the laser machine tool that most typically operate under numerical control.

Also known are beam analyzing devices which are used to determine the beam characteristics of a laser beam in a laser machine tool. A beam analyzing device of that nature has been marketed by PROMETEC GmbH, of 52070 Aachen, Germany, under the trademark LASERSCOPE UFF 100. Disclosed in publication DE 199 09 595 A1 are a beam analyzing unit and a beam analyzing method. These earlier beam analyzing units are self contained or stand alone units which are separately functional and can be used as needed in conjunction with equally self contained laser machine tools.

It is the objective of this invention to introduce a novel laser machine tool which incorporates a beam analyzing unit to optimize beam characteristics.

Another objective is to provide such a laser machine tool in which the guidance system and numeric control enable facile analysis of the laser beam and modification of the laser beam impinging upon the workpiece.

### SUMMARY OF THE INVENTION

It has now been found that the foregoing and related objects may be readily attained in a laser machine tool having a workpiece support, a laser beam functional unit, and a drive mechanism for effecting relative movement between the laser beam functional unit and workpiece support. Combined therewith is a beam analyzer for the determination of at least one beam characteristic of the laser beam, and the drive mechanism of the laser machine tool effects movement of the laser beam functional unit relative to a beam detection element in the beam analyzer to capture the laser beam cross section in segments by the beam detection element as the beam is moved relative to the analyzer in the transverse direction of the beam. The drive mechanism of the laser machine tool includes a numerical control unit which detects the position of the laser beam in the machine coordinate system and which, on the basis of the detected position(s) of the laser beam within the machine coordinate system, controls the drive mechanism for relative movement between the beam focal spot and the workpiece for the processing of the workpiece, as well as for a relative movement between the laser beam and the beam detection element for performing analysis of the beam.

In one embodiment, the beam analysis, a beam detection element in the beam analyzer and the unfocused laser beam are moved relative to each other in the transverse beam direction by means of the drive mechanism of the laser machine tool.

In a further embodiment, the beam detection element in the beam analyzer and the operationally focused laser beam are moved relative to each other in the transverse beam direction by means of the drive mechanism of the laser machine tool.

In a still further another mode, the laser beam is in a state of reduced output power from the laser beam source and the beam detection element of the beam analyzer and the operationally focused laser beam are movable relative to each other in the transverse beam direction by means of the drive mechanism of the laser machine tool.

Generally, the drive mechanism causing the relative movement between the beam detection element of the beam analyzer and the laser beam is the drive mechanism of the laser machine tool by which a laser processing head as the functional unit serving to process the workpiece can be moved relative to a workpiece and by means of which the laser beam can be moved relative to the beam detection element of the beam analyzer in the transverse beam direction for the purpose of the beam analysis.

In one embodiment, the beam detection element of the beam analyzer is positioned in a fixed location outside the work area of the laser beam functional processing unit, and the drive mechanism is operated to move the laser beam relative to the fixed location. In another embodiment, the drive mechanism causing the relative movement of a beam detection element of the beam analyzer and the laser beam moves the work support relative to the laser beam functional unit and the beam detection element of the beam analyzer is moved relative to the laser beam functional unit in the transverse beam direction for the purpose of the beam analysis. The beam analyzer serves to determine the beam profile and/or the beam intensity distribution across the beam diameter and/or the laser beam position and/or the laser output level. Usually, the beam detection element is a thermal sensor.

As illustrated and described, the beam analyzer device is integrated into the laser machine tool. For the beam analysis, the necessary relative movement of the laser beam and a beam detection element of the beam analysis device is carried out by means of the drive mechanism of the laser machine tool. This drive mechanism also controls the relative movement between the focal spot of the laser beam and the workpiece for the machining of the latter. For such dual functionality according to the invention, it is possible to adapt various drive mechanisms that have traditionally been used for laser based machine tools. The only added capability required is that of a controlled relative movement between the laser beam and the beam detection element of the beam analysis device in the transverse direction of the beam. This invention obviates the need for providing a laser machine tool and a separate beam analyzer for the determination of beam characteristics as stand alone units. Such a laser machine tool with integrated laser beam diagnostic capability thus minimizes the purchase cost of the system.

The configuration of the laser machine tool is characterized by a particularly high level of integration. The design of that laser machine tool makes dual use not only of the mechanical components of a drive mechanism of the laser machine tool but also of the components of the associated numerical control system. For controlling the process related relative movement between the laser beam focal spot and the workpiece as well as for controlling the relative movement between a beam detection element of the beam analysis device and the laser beam, it is necessary for the position of the laser beam to be defined within a coordinate system of the laser machine tool and to constitute a known factor. In the laser machine tool, the positional data for both relative movements are provided by the same control module.

Preferably, the relative movement is between a beam detection element of the beam analyzer and an as yet unfocused laser beam. The advantage of this step is that the beam detection element employed is exposed to relatively low temperatures only.

However, in the case the laser beam may be captured in its ultimately focused state. The required beam characteristics are determined in the state of the laser beam in which the laser beam impinges on the workpiece that is to be processed. Thus, the result of the beam analysis performed reflects the actual conditions prevailing at the processing point.

Desirably, to prevent thermally induced damage to the beam detection element, the ultimately focused laser beam to be captured by the beam detection element of the beam analyzer when the source of the laser beam is in a state of reduced output power.

A preferred configuration of the laser machine tool of this invention employs for the beam analyzer a drive mechanism that also moves the laser machining head relative to the object workpiece to be processed. In a great many cases this drive mechanism also permits multiaxial movements. In keeping with the demanding accuracy requirements in the processing of the workpiece, a highly precise movement of the laser beam relative to the beam detection element of the beam analysis device is assured for the beam analysis as well. The result of the beam analysis will be correspondingly accurate.

In one embodiment, usually the beam detection element of the beam analyzing device is conveniently located in a fixed stationary position outside the work area of the laser machining head.

The laser machine tool may utilize for the beam analysis the motive capabilities of a workpiece support that holds the workpiece during the processing. A beam detection element of the beam analyzing device is moved jointly with the workpiece support relative to the laser beam. The advantage of this feature lies in the fact that the laser beam concerned remains in a consistent state throughout the beam analysis. This avoids any changes in that state that might otherwise result from corrective adjustments of the laser beam guide during the movement of the laser beam.

The preferred design implementation of the invention uses for the beam detection element a temperature sensor. The thermal conditions permit conclusions as to numerous laser beam characteristics.

### BRIEF DESCRIPTION OF THE DRAWINGS

The following describes this invention in more detail based on an implementation example and with the aid of stylized illustrations in which:

FIG. 1 illustrates a laser cutting machine with a beam analyzing device embodying the present invention for the processing of a workpiece;

FIG. 2 is a fragmentary illustration of the components of the laser cutting machine of FIG. 1 during beam analysis; and

FIG. 3 diagrammatically illustrates the sensor assembly of the beam analyzing component of FIGS. 1 and 2.

### DETAILED DESCRIPTION OF THE PREFERRED EMBODIMENT

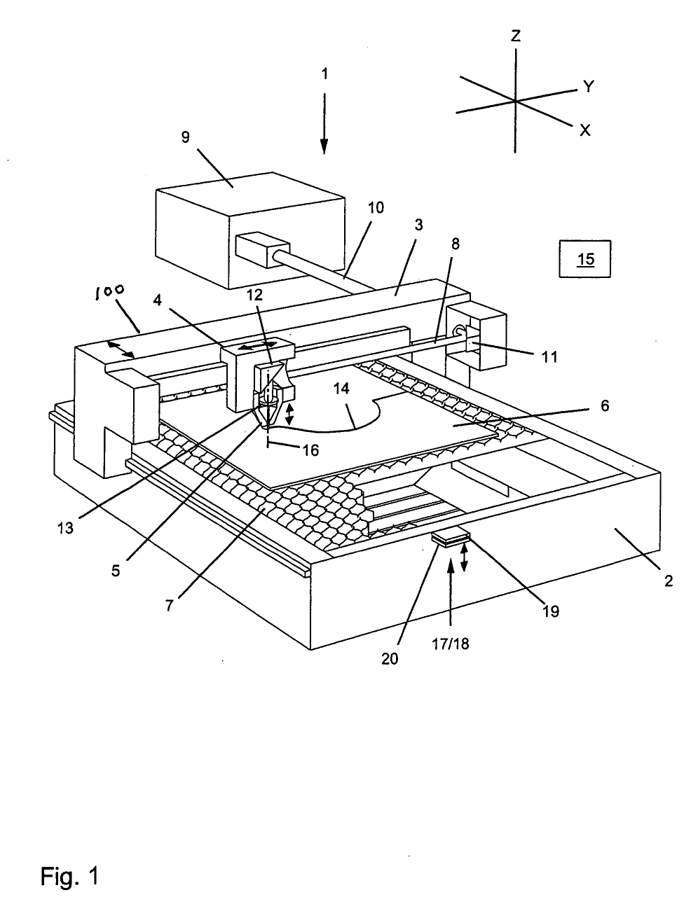

FIG. 1 illustrates a laser machine tool installation embodying the present invention including a laser cutting machine generally designated by the numeral 1 with a machine bed 2 on which the machine bridge 3 is movably guided in a first axial direction (x-axis). The machine bridge 3 has a cross bar 100 which supports a guide block 4 on which is mounted a laser processing, i.e., cutting head 5, shown in section. The guide block 4 and laser cutting head 5 can travel in a second axial direction (y-axis) along the cross bar 100 of the machine bridge 3. In addition, the laser cutting head 5 can move relative to the guide block 4 in a third axial direction (z-axis). Underneath the laser cutting head 5, a workpiece 6 in the form of a metal plate is located on the work support 7 inside the machine bed 2.

The workpiece 6 is processed by a laser beam 8 generated by a laser beam generator 9. From the laser beam generator 9 the laser beam 8 passes through a tubular beam guide 10 to the machine bridge 3 where a first beam deflector 11 redirects the laser beam 8 in a direction parallel to the cross bar 100 of the machine bridge 3 toward a second beam deflector 12 on the guide block 4. The second beam deflector 12 reflects the laser beam 8 onto a focusing lens 13 which focuses the laser beam 8 and directs it onto the workpiece 6 to effect the cutting of the workpiece. Since the machine bridge 3 can travel along the x-axis and the guide block 4 can travel along the y-axis, the laser beam 8 can be moved to any spot on the workpiece 6. FIG. 1 shows how in the implementation example illustrated, a complexly curved cut 14 is made in the workpiece 6. The ability of the laser cutting head 5 to move in the z-axis is utilized for the positional adjustment of the focal spot of the laser beam 8 in the thickness direction of the workpiece 6. Such positional adjustment of the focal spot can be made prior to but also during the cutting process.

A motorized drive mechanism with a numerical control unit 15 serves to move the laser cutting head 5 in the three spatial directions. The numerical control unit 15 controls the drive that moves the machine bridge 3 along the x-axis, the drive that moves the guide block 4 along the y-axis, and the drive that moves the laser cutting head 5 along the z-axis operate in mutually coordinated fashion. For their control, the other functions of the laser cutting machine 1 are similarly integrated into the control operation of the numerical control unit 15.

Positioned outside the processing area of the laser cutting head 5 at the long end of the machine bed 2 is a sensor assembly generally designated by the numeral 17 in the beam analyzing unit 18. The sensor assembly 17 is located in a defined position within the coordinate system constituted by the x-, y- and z-axes of the laser cutting machine 1.

As shown in detail in FIG. 3, the sensor assembly 17 includes a cooled pinhole aperture 19 and, underneath the latter as the beam detection element, a thermal sensor 20. The thermal sensor 20 connects to an evaluation component of the beam analysis device 18 which on its part is integrated into the numerical control unit 15 of the laser cutting machine 1. On the machine bed 2, the sensor assembly 17 can be adjusted along the z-axis.

The beam analyzing device 18 permits the determination of various beam characteristics of the laser beam 8. These beam characteristics include, among others, the beam intensity distribution across the diameter of the laser beam 8 as well as the spatial position of the vertical section of the laser beam 8, i.e. its beam axis 16.

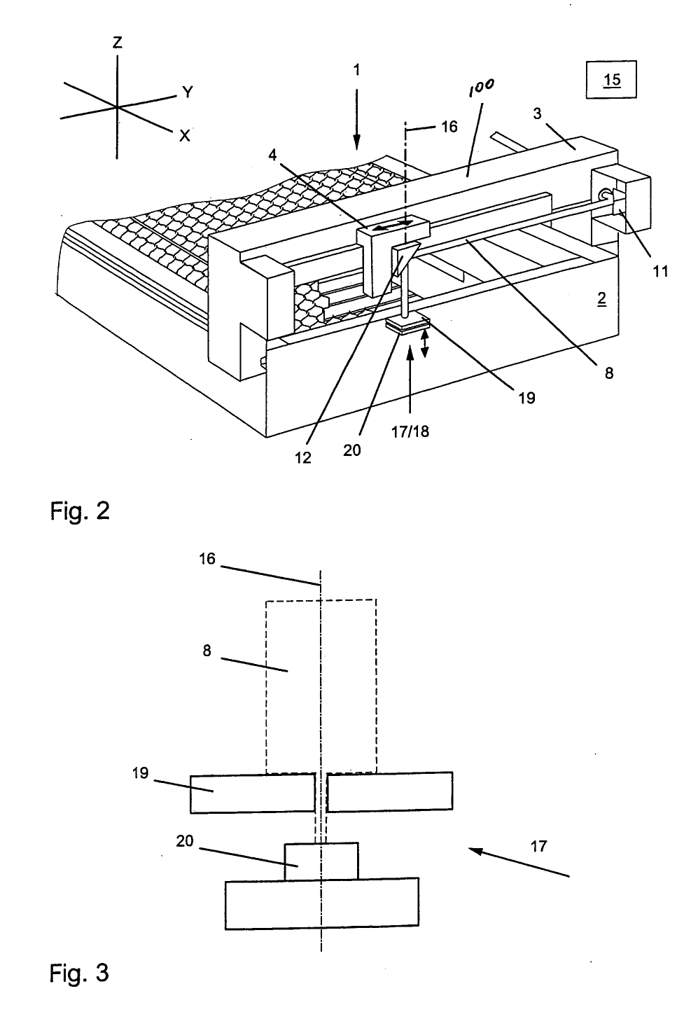

For the beam analysis, the machine bridge 3 with the guide block 4 and the laser cutting head 5 are moved by means of the corresponding drive to the end of the machine bed 2 where the sensor assembly 17 is located. There, the laser cutting head 5 including the focusing lens 13 is removed. The second beam deflector 12 on the guide block 4 directs the laser beam 8, now no longer in its final focused state, onto the sensor assembly 17 as shown in FIG. 2.

By moving the machine bridge 3 and the guide block 4, the laser beam 8 is passed in the x- and y-direction across the pinhole aperture 19. The diameter of the aperture 19 is smaller than the diameter of the laser beam 8. It follows that only a segment of the beam diameter passes through the pinhole of the aperture 19 and reaches the thermal sensor 20. Thus, the thermal sensor 20 scans the cross section of the laser beam 8 one segment at a time.

An evaluation unit in the beam analyzing unit 18 serves to identify, for each captured and positionally defined cross-sectional segment of the laser beam 8, the temperature detected therein. The individual cross-sectional segments and their respective temperature levels are then combined into a composite beam cross section with a resulting temperature profile. It is in this fashion that the beam intensity distribution across the diameter of the laser beam 8 is determined.

Scanning the laser beam 8 with the thermal sensor 20 also enables the evaluation unit of the beam analyzing unit 18 to determine the position of the laser beam cross section in the plane of the thermal sensor 20. If and when the position of the horizontal plane of the thermal sensor 20 changes due to a raising or lowering of the sensor assembly 17 along the z-axis, a renewed scan of the laser beam 8 permits the determination of the position of the laser beam cross section in the new plane. The extent of the shift between the two planes of the thermal sensor 20 is a known factor. The shift of the cross sections of the laser beam 8 in the plane of the thermal sensor 20 in the x- and/or y-directions along with the shift between the beam cross sections in the z-direction corresponding to the shift of the planes of the thermal sensor permits the determination of the spatial position of the beam axis 16.

The information obtained by means of the beam analysis device 18 is then used to optimize the workpiece processing performance of the laser cutting machine 1 in accordance with known computer functions.

Thus, it can be seen from the foregoing detailed description and attached drawings that the novel laser machine tool of the present invention enables rapid and convenient analysis of the laser beam to optimize the beam for the machining operation.

1. In a laser machine tool having a workpiece support, a laser beam functional unit, and a drive mechanism for effecting relative movement between the laser beam functional unit and workpiece support, the combination therewith of a beam analyzer for the determination of at least one beam characteristic of the laser beam, said drive mechanism of the laser machine tool effecting movement of the laser beam functional unit relative to a beam detection element in the beam analyzer, whereby the laser beam cross section is captured in segments by the beam detection element as the beam is moved relative to the analyzer in the transverse direction of the beam.

2. The laser machine tool in accordance with claim 1 wherein the drive mechanism of the laser machine tool includes a numerical control unit which detects the position of the laser beam in the machine coordinate system and which, on the basis of the detected position(s) of the laser beam within the machine coordinate system, controls the drive mechanism for relative movement between the beam focal spot and the workpiece for the processing of the workpiece, as well as for a relative movement between the laser beam and the beam detection element for performing analysis of the beam.

3. The laser machine tool in accordance with claim 1 wherein, for the beam analysis, a beam detection element in the beam analyzer and the unfocused laser beam are moved relative to each other in the transverse beam direction by means of the drive mechanism of the laser machine tool.

4. The laser machine tool in accordance with claim 1 wherein, for the beam analysis, a beam detection element in the beam analyzer and the operationally focused laser beam can be moved relative to each other in the transverse beam direction by means of the drive mechanism of the laser machine tool.

5. The laser machine tool in accordance with claim 1 wherein, for the beam analysis, the laser beam is in a state of reduced output power from the laser beam source and the beam detection element of the beam analyzer and the operationally focused laser beam are movable relative to each other in the transverse beam direction by means of the drive mechanism of the laser machine tool.

6. The laser machine tool in accordance with claim 1 wherein the drive mechanism causing the relative movement between the beam detection element of the beam analyzer and the laser beam is the drive mechanism of the laser machine tool by which a laser processing head as the functional unit serving to process the workpiece can be moved relative to a workpiece and by means of which the laser beam can be moved relative to the beam detection element of the beam analyzer in the transverse beam direction for the purpose of the beam analysis.

7. The laser machine tool in accordance with claim 1 wherein the beam detection element of the beam analyzer is positioned in a fixed location outside the work area of the laser beam functional processing unit, and the drive mechanism is operated to move the laser beam relative to the fixed location.

8. The laser machine tool in accordance with claim 1 wherein the drive mechanism causing the relative movement of a beam detection element of the beam analyzer and the laser beam moves the work support relative to the laser beam functional unit and the beam detection element of the beam analyzer is moved relative to the laser beam functional unit in the transverse beam direction for the purpose of the beam analysis.

9. The laser machine tool in accordance with claim 1 wherein the beam analyzer serves to determine the beam profile and/or the beam intensity distribution across the beam diameter and/or the laser beam position and/or the laser output level.

10. The laser machine tool in accordance with claim 1 wherein the beam detection element is a thermal sensor.

11. A method for the determination of at least one beam characteristic of a laser beam in a laser machine tool, comprising providing a machine tool with a laser beam functional unit for generating a laser beam and a beam analyzer with a beam detection element, and moving the laser beam and beam detection element relative to each other in the transverse direction of the beam to capture the cross section of the laser beam for analysis.

12. The method for the determination of at least one beam characteristic in accordance with claim 11 wherein said beam detection element is a thermal sensor.

13. The method for the determination of at least one beam characteristic in accordance with claim 11 wherein the beam analyzer serves to determine the beam profile and/or the beam intensity distribution across the beam diameter and/or the laser beam position and/or the laser output level.

14. The method for the determination of at least one beam characteristic in accordance with claim 11 wherein, for the beam analysis, a beam detection element in the beam analyzer and the unfocused laser beam are moved relative to each other in the transverse beam direction by means of the drive mechanism of the laser machine tool.

15. The method for the determination of at least one beam characteristic in accordance with claim 11 wherein, for the beam analysis, a beam detection element in the beam analyzer and the operationally focused laser beam are moved relative to each other in the transverse beam direction by means of the drive mechanism of the laser machine tool.

16. The method for the determination of at least one beam characteristic in accordance with claim 11 wherein, for the beam analysis, the laser beam is in a state of reduced output power of the laser beam source and the beam detection element of the beam analyzer and the operationally focused laser beam are moved relative to each other in the transverse beam direction by means of the drive mechanism of the laser machine tool.
